(19) United States
(12) Patent Application Publication
(10) Pub. No.: US 2015/0201656 A1
(43) Pub. Date: Jul. 23, 2015

(54) EXTRUDED FOOD

(71) Applicants: Chuling Claire Liang, Beijing (CN); Olivier Ballevre, Amiens (FR); Catherine Dionis, Beijing (CN); Yongcheng Liao, Beijing (CN)

(72) Inventors: Chuling Claire Liang, Beijing (CN); Olivier Ballevre, Amiens (FR); Catherine Dionis, Beijing (CN); Yongcheng Liao, Beijing (CN)

(73) Assignee: NESTEC S.A., Vevey (CH)

(21) Appl. No.: 14/414,826

(22) PCT Filed: Jul. 18, 2012
(86) PCT No.: PCT/CN12/78804

§ 371 Date: Jan. 14, 2015

(51) Int. Cl. A23L 1/214; A23P 1/12; A23P 1/14; A23L 1/00

(52) U.S. Cl. CPC A23L 1/2142; A23L 1/0076; A23P 1/12; A23P 1/14; A23V 2002/00

(57) ABSTRACT

Extruded food puffs comprising sweet potato have a density between 0.15 and 0.52 g/cm³. The sweet potato may be purple sweet potato. A composition comprising the extruded food puffs and a process for manufacturing extruded food puffs.

The present invention relates generally to the field of food products. One aspect of the invention is to provide extruded food puffs comprising sweet potato. The extruded food puffs may have a density between 0.15 and 0.52 g/cm³. The sweet potato may be purple sweet potato. The invention also provides a composition comprising the extruded food puffs. A further aspect of the invention is a process for manufacturing extruded food puffs.

Sweet potato (Ipomoea batatas) is an important crop worldwide. All varieties of sweet potato are good sources of vitamins C, B2 (Riboflavin), B6 and E as well as dietary fibre, potassium, copper, manganese and iron, and they are low in fat and cholesterol (G. Loebenstein et al., The Sweetpotato, Springer Science, 2009). However, the range of food products which can currently be made with sweet potato is limited. Traditionally, sweet potato is boiled, steamed, or baked.

Sweet potato flesh can be white, orange, yellow, purple, red, pink and violet. Varieties with purple flesh (purple sweet potato) are becoming increasingly popular as a food ingredients due to their attractive colour, and also because they provide a rich source of anthocyanins which deliver nutritional benefits. Purple sweet potato can also be dried to a powder and added to beverages or desserts, giving them an attractive colour. CN101647529 describes using extrusion to form rice-shaped grains from ingredients including purple sweet potato. These rice-shaped grains can be cooked as a substitute for rice, having a similar texture to rice but with the nutritional benefits of purple sweet potato.

Sweet potato is such a nutritious vegetable that it would be beneficial to increase its worldwide consumption. One way to do this would be to develop new types of products made from sweet potato. In particular, it would widen the consumer appeal of sweet potato if products were available with a crisp texture.

Sweet potato can be sliced and fried like a standard potato to form crisps (called “chips” in the USA), but the results are substantially different. Natural products such as sweet potatoes with relatively high levels of reducing sugars become rubbery during cooking and need to be cooked to very high temperatures before they become crispy. These high temperatures can cause the product to burn, spoiling the flavour. In addition, frying causes the sweet potato to absorb fat. Fried crisps typically have around 35% fat and so are not perceived as healthy by consumers.

Extruding sweet potato to form an expanded crispy product is problematic. Khalil found that extrusion of sweet potato resulted in a brittle, dense and burnt extrudate, due to the high levels of sugar in the sweet potato (H. M. Khalil et al., Food Science and Technology International, 3, 171-174 (1997)). The problem is made worse by the endogenous amylase in sweet potato which converts starch into additional sugars during heat treatments such as drying sweet potato flesh to form a powder, or during extrusion cooking, before the temperature has increased sufficiently to inactivate the enzyme. Khalil experimented with adding other starch-containing materials such as wheat flour to sweet potato solids in an attempt to obtain an expanded sweet potato snack product by extrusion. However he found that, even by reducing the sweet potato solids content to 50%, it was only possible to achieve a density of 0.57 g/cm³ with a limited expansion factor of 1.53. This product lacked the expected crunch of an extruded food.

US2006/0286242 discloses making a sweet potato snack chip by cooking dough which comprises sweet potato flour. Although the density of the chips produced is relatively high (over 0.6 g/cm³), the product shape, similar to a sliced potato crisp, produces a sharp fracture when bitten and so is perceived as crunchy and crisp in texture.

JP03123442 discloses extruding a mixture of sweet potato, starch and sugar and obtaining a crispy product by forming hollow pillow shapes. The shapes are formed by extruding a hollow tube which is then crimped and cut to form hollow pieces with closed ends. The hollow pillow shapes fracture when bitten and so are perceived as crisp.

It would be advantageous to be able to provide a crisp sweet potato product without being limited to hollow pillow, snack chip or potato crisp shapes. In particular it would be beneficial to provide crispy sweet potato products with a size and shape suitable for being added as inclusions in a breakfast cereal, used as a crispy decoration or included in a cereal bar. It would therefore be desirable to overcome the limitations identified in the prior art and be able to extrude a sweet potato product with sufficiently low density to achieve an inherently crispy texture.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

The object of the present invention is to improve the state of the art and in particular to provide an extruded food overcoming at least some of the disadvantages described above or to at least provide a useful alternative.

The inventors were surprised to see that the object of the present invention could be achieved by the subject matter of the independent claims. The dependent claims further develop the idea of the present invention.

Accordingly, the present invention provides extruded food puffs comprising sweet potato having a density between 0.15 and 0.52 g/cm³. The inventors surprisingly found that by maintaining the extruder barrel temperature below 150° C. and the moisture content of the ingredients in the extruder below 20% they were able to obtain a high expansion of sweet potato materials and avoid burning, despite the high levels of sugar in sweet potato. The resulting extruded food puffs had a low-density expanded structure and a crispy texture.

The invention also relates to a process for manufacturing extruded food puffs comprising the steps of preparing a dry-mix of ingredients comprising between 20 and 85% sweet potato on a dry basis; mixing water with the dry-mix ingredients such that the total water content is between 11 and 20%; extruding the dry-mix ingredients and water together with oil at an extrusion temperature of between 125 and 150° C.; extruding through a die to form an extrudate with an expansion factor greater than 2, preferably greater than 3; cutting the extrudate and drying the extrudate to a moisture content below 5%. The inventors found that this process permitted the manufacture of extruded sweet potato food puffs with good expansion and a pleasant crispy texture.

Consequently the present invention relates in part to extruded food puffs comprising sweet potato having a density between 0.15 and 0.52 g/cm³, for example between 0.2 and 0.4 g/cm³. An extruded food puff which has expanded sufficiently to have a density below 0.52 g/cm³ provides a good eating texture. The expanded low density structure fills the mouth, giving an impression of having plenty to eat, while in fact delivering only a few calories. This is beneficial for people who do not want to eat too much, for example those who do not wish to gain body weight.

Extruded food is food material which has been forced to flow, under conditions of mixing, heating and shear, through a die which is designed to form the ingredients.

Generally the extruded food is cut into pieces at, or soon after, the exit of the die. Puffs are formed when the pressure and temperature are so regulated in the extruder that the food reaches a temperature above the boiling point of water. When the shaped food emerges from the extruder, the heated water rapidly boils as pressure is relieved at the exit die. This causes puffing of the formed piece. Such formed and puffed pieces may then receive additional oven drying. Puffs have internal porosity, but they are not totally hollow. The interior of a puff has internal structure, whereas a hollow product has an exterior shell and just a cavity within. The internal structure of a puff contributes to its sensory characteristics. As the puff is bitten, the collapse of multiple internal structures creates auditory and vibratory sensations in the mouth, experienced by the consumer as a pleasant crispy texture.

The sweet potato (Ipomoea batatas) is a dicotyledonous plant that belongs to the family Convolvulaceae. It has large, starchy, sweet-tasting, tuberous roots, eaten as a root vegetable. Sweet potatoes vary in taste, size, shape and texture, although all are smooth-skinned with roots. Orange fleshed sweet potatoes are often known as yams, especially in the southern United States, but sweet potatoes are not the same as true yams (Dioscorea sp.).

In the present invention, density refers to the piece density, sometimes called specific weight. This is the total mass of the pieces divided by the volume of all the individual pieces, including any internal porosity. It is distinct from bulk density which also includes the inter-piece void volume. Piece density is an unvarying parameter unlike bulk density which can alter, for example if the pieces are vibrated and settle closer together.

The extruded food puffs of the invention may have a crispy texture. Crispy textured products have wide consumer appeal, especially as snack foods. Crispy in the scope of the current invention is considered equivalent to the Duizer definition of crispness, a combination of the noise produced and the breakdown of the product as it is bitten entirely through with the back molars (L. M. Duizer et al., Journal of Texture Studies, 29, 397-411 (1998)). It is an advantage that this low density crispy texture can be created without frying, as frying increases the amount of oil in the product. In one example of the invention the extruded food puffs have not been fried.

The current invention provides a crispy sweet potato product which is not limited in form to a hollow pillow shape; or a snack chip or potato crisp shape. The low density expanded structure of the invention provides an inherently crispy eating texture. Small extruded low density puffs have a wide range of possible applications where a larger shape would not be suitable. For example they can be added as inclusions in a breakfast cereal. The extruded food puffs may have a maximum dimension less than 30 mm, for example less than 15 mm.

Extrusion according to the present invention allows a range of shapes to be produced simply by changing the die on the extruder. Different shapes make the extruded food puffs more fun to eat, especially for children. The extruded food puffs may have cross-sectional shapes selected from the group consisting of circle, oval, square, triangle, ring, crescent, heart, star, fish, cartoon character and letters of the alphabet. Puffs with different shapes may be combined such that, in bulk, a variety of shapes are present.

The extruded food puffs of the invention may be spherical. By cutting short lengths of the extrudate as it emerges from the extruder die the expansion of the extrudate forms spherical pieces. The extruded food puffs will not be all exactly the same size and shape, but in this invention the term spherical means that the shapes are rotationally symmetrical within an allowed tolerance of 15% of the diameter.

The extruded food puffs may contain on a dry basis between 20 and 95% sweet potato, preferably between 40 and 95% sweet potato, for example between 60 and 95% sweet potato, by further example between 70 and 95% sweet potato. As sweet potato provides nutritional benefits it is advantageous to be able to include high percentages of sweet potato in any extruded food puff.

The sweet potato in the extruded food puffs of the invention may be added in the form of sweet potato powder, sweet potato flakes or mixtures thereof. The term sweet potato powder includes material sold as sweet potato flour. The sweet potato powder may be partially or fully gelatinized.

The extruded food puffs may have an expansion factor greater than 2, preferably greater than 3. The expansion factor (sometimes simply called Expansion) is the ratio between the extrudate diameter and the die orifice diameter. Achieving a high expansion factor is beneficial as it results in a low density product.

An important source of colour in pigmented sweet potato varieties is anthocyanins. These anthocyanins have anti-oxidant and other health benefits. Acylated anthocyanins predominate in pigmented sweet potatoes which is advantageous as acylated anthocyanins are more heat and light stable than other anthocyanins. Many consumers would prefer not to eat artificial colours and so providing extruded food puffs which have a natural attractive colour is beneficial. Sweet potato varieties with red, purple or orange flesh are sweeter than those with pale yellow or white flesh (G. Loebenstein et al., The Sweetpotato, Springer Science, 2009). However, an increased sugar content presents problems for extrusion processing, leading to a brittle, dense and burnt extrudate. The inventors were surprised to find that the process of this invention was able to successfully extrude, e.g., purple sweet potatoes without the above-mentioned problems. The food puffs have an attractive purple colour which is not significantly affected by the extrusion process. The extruded food puffs of the invention may have a red, pink or purple colour wherein the sweet potato imparts the red, pink or purple colour to the extruded food puffs. Being able to provide extruded food puffs comprising purple sweet potato has further advantages as purple sweet potato is perceived by consumers, especially Chinese consumers, to be good for digestion. The sweet potato in the extruded food puffs of the invention may be purple sweet potato.

Sweet potato in the current invention may be combined with other starch sources. This flexibility is beneficial to be able to provide additional nutrients, flavours or to reduce the recipe cost. For extruded purple sweet potato puffs, the greater the amount of purple sweet potato the stronger the purple sweet potato taste and the purple colour. Extruded food puffs according to current invention may comprise on a dry basis between 20 and 85% purple sweet potato; between 1 and 7% oil or fat, and between 10 to 75% of a starch-containing ingredient selected from the group consisting of non-purple sweet potato, rice, wheat, tapioca, corn, potato (Solanum tuberosum), and mixtures of these. For example, the starch-containing ingredient may be rice. The extruded food puffs may comprise on a dry basis between 60 and 85% purple sweet potato; between 1 and 7% oil or fat, and between 10 to 35% of a starch-containing ingredient selected from the group consisting of rice, wheat, tapioca, corn, potato (Solanum tuberosum), and mixtures of these. The nature of the oil or fat is not particularly limited. It is convenient to use an oil (liquid at room temperature) to allow dosage via an injection port on the extruder. The oil or fat may be selected from the group consisting of palm oil, palm kernel oil, corn oil, sunflower oil, peanut oil and soybean oil and mixtures of these.

Other ingredients may be added, for example to enhance processing or flavour. Calcium carbonate may be added to increase water vapour bubble nucleation in the hot melt fluid within the extruder, promoting good expansion. Sucrose may be added, especially in the recipes which are lower in sweet potato, to provide sweetness and act as a humectant. Extruded food puffs according to the invention may further comprise on a dry basis up to 10% added sucrose and/or up to 1% calcium carbonate. The term “added sucrose” refers to sucrose directly added as an ingredient, as distinct from sucrose which may form an intrinsic part of other ingredients.

The extruded food puffs of the present invention may be used in a number of product applications. The good nutritional profile of sweet potato, particularly purple sweet potato, makes the extruded food puffs ideal for forming part of a nutritional composition. Accordingly, a further embodiment of the invention provides a composition comprising extruded food puffs wherein the composition is a food composition or a nutritional composition.

The extruded food puffs may be inclusions within the composition comprising them. For example, their crisp texture and small size is ideal for use as a cereal inclusion, or for adding to ice cream where the extruded food puffs provide textural contrast. When the puffs comprise pigmented sweet potatoes such as purple sweet potatoes, then the puffs also add attractive natural colour to the material in which they are included.

The extruded food puffs add sweetness and natural colour when added to foods for infants. The puffs may also be included in a confectionery product to add a low density crisp texture. For example, purple sweet potato puffs give visual and textural contrast when included in white chocolate. They may also be incorporated into cereal bars, chocolate puffed-rice cakes or the Chinese pastry called sachima. Extruded food puffs comprising sweet potato provide a texture and flavour which is appealing to pets as well as humans. Accordingly, a composition comprising extruded food puffs of the invention may be a food composition selected from the group consisting of a pet food; a breakfast cereal; a food for infants; a dehydrated soup; a dehydrated porridge; a confectionery product; a cereal bar; a bakery or pastry product, for example sachima; or an ice cream.

A further embodiment of the invention is a process for manufacturing extruded food puffs. The process comprises the steps of preparing a dry-mix of ingredients comprising more than 20% sweet potato on a dry basis, for example more than 40% sweet potato, for further example more than 60% sweet potato; mixing water with the dry-mix ingredients such that the total water content is between 10 and 20%, for example between 11 and 15%; extruding the dry-mix ingredients and water together with oil or fat at an extrusion temperature of between 125 and 150° C.; extruding through a die to form an extrudate with an expansion factor greater than 2, preferably greater than 3; cutting the extrudate; and drying the extrudate to a moisture content below 5%, for example below 3%. The sweet potato in the process may be purple sweet potato. The process of the invention makes it possible to produce extruded food puffs comprising sweet potato with a low density and crispy texture, overcoming the problems of the prior art such as avoiding the production of a dense and/or burnt extrudate.

Those skilled in the art will understand that they can freely combine all features of the present invention disclosed herein. In particular, features described for the product of the present invention may be combined with the process of the present invention and vice versa. Further, features described for different embodiments of the present invention may be combined. Where known equivalents exist to specific features, such equivalents are incorporated as if specifically referred in this specification. Further advantages and features of the present invention are apparent from the non-limiting examples.

### EXAMPLES

### Preparation of Extruded Food Puffs

A range of recipes were prepared, processed in a twin-screw extruder and then dried.

### Dry-Mix

| Ingredient (%) | Trial A | Trial B | Trial C | Trial D |
|---|---|---|---|---|
| Purple sweet potato (PSP) | 25 | 50 | 80 | 36 |
| powder | | | | |
| Sweet potato powder | — | — | — | 4 |
| Wheat flour | — | — | — | 34 |
| Rice | 69.5 | 44.5 | 14.5 | 20 |
| Sugar | 5 | 5 | 5 | 5 |
| Calcium carbonate | 0.5 | 0.5 | 0.5 | 1.0 |
| Overall dry-mix moisture (%) | 12 | 12 | 12 | 12 |

### Process Parameters

| | Trial A | Trial B | Trial C | Trial D |
|---|---|---|---|---|
| Dry mix (kg/h) | 100 | 100 | 100 | 70 |
| Process water (kg/h) | 4 | 7 | 7 | 14 |
| Palm oil (kg/h) | 6 | 3 | 3 | 2 |
| Total water (%) | 14.5 | 17.3 | 17.3 | 26.0 |
| Screw speed (rpm) | 350 | 350 | 350 | 252 |
| Cutter speed | 3500 | 3500 | 3500 | 3814 |
| Extrusion temperature (° C.) | 146 | 141 | 141 | 131 |
| Moisture before drying (%) | 4.2 | 4.7 | 3.9 | 12.5 |
| Moisture after drying (%) | 1.0 | 1.8 | 1.6 | 2.2 |

The texture, flavour and appearance of the puffs were assessed by a small sensory panel. Crispiness was assessed by evaluating the noise produced and the breakdown of the product as it was bitten entirely through with the back molars. The density of the puffs (specific weight) was measured by the following procedure using sunflower oil, a graduated cylinder and a balance.

### Procedure:

1) Tare the clean graduated cylinder on the balance.

2) Place approximately 10 g of unbroken extruded puffs into the graduated cylinder.

4) Weigh the graduated cylinder on the tared balance. This is the mass of the extruded puffs (m_{puffs}).

5) Slowly fill the graduated cylinder containing the puffs to the upper-most graduation mark (V_{cyl}) with sunflower oil, ensuring no air bubbles are contained in the filled graduated cylinder.

6) Weigh the graduated cylinder containing the puffs and sunflower oil (m_{puff&oil}).

### Calculations:

Mass of oil=m_{puff&oil}−m_{puffs}

Volume of oil=Mass of oil/Density of oil (measured as 0.9064 g/cm³)

Volume of puffs=V_{cyl}−Volume of oil

Density of puffs=m_{puffs}/Volume of puffs

### Results

| | Trial A | Trial B | Trial C | Trial D |
|---|---|---|---|---|
| Expansion | 6.42 | 5.54 | 3.15 | 2.40 |
| ratio | | | | |
| Density | 0.23 | 0.30 | 0.38 | 0.75 |
| (g/cm³) | | | | |
| Descrip- | Crispy | Crispy | Good | Hard, non |
| tion | texture. | texture. | crispiness. | crispy |
| | Weak colour | Good purple | Colour similar | texture. |
| | and PSP | colour and | to Trial B. | Colour similar |
| | taste. | perceptible | Strong PSP | to Trial B. |
| | | PSP taste. | taste | |

Trials A, B and C were made according to the process of the invention and resulted in puffs with a good crispy texture. The density increased with the amount of sweet potato. Trial D did not give a crispy puffed product due to the higher water content in the mixture.

1. Extruded food puffs comprising sweet potato having a density between 0.15 and 0.52 g/cm³.

2. Extruded food puffs according to claim 1 which have a crisp texture.

3. Extruded food puffs according to claim 1 having a maximum dimension of less than 30 mm.

4. Extruded food puffs according to claim 1, wherein the puffs have a cross-sectional shape selected from the group consisting of circle, oval, square, triangle, ring, crescent, heart, star, fish, cartoon character and letters of the alphabet.

5. Extruded food puffs according to claim 1, wherein the puffs are spherical.

6. Extruded food puffs according to claim 1, wherein the puffs contain on a dry basis between 20 and 95% sweet potato.

7. Extruded food puffs according to claim 1, wherein the sweet potato is added in the form of sweet potato powder, sweet potato flakes or mixtures thereof.

8. Extruded food puffs according to claim 1, wherein the expansion factor is greater than 2.

9. Extruded food puffs according to claim 1, wherein the sweet potato is a purple sweet potato.

10. Extruded food puffs according to claim 9 wherein the puffs comprise on a dry basis: between 20 and 85% purple sweet potato; between 1 and 7% oil or fat; and between 10 and 75% of a starch-containing ingredient selected from the group consisting of non-purple sweet potato, rice, wheat, tapioca, corn, potato (Solanum tuberosum) and mixtures of these.

11. Extruded food puffs according to claim 10 further comprising on a dry basis up to 10% added sucrose and/or up to 1% calcium carbonate.

12. Composition comprising extruded food puffs according to claim 1, wherein the composition is a food composition or a nutritional composition.

13. Composition according to claim 12 wherein the puffs are inclusions within the composition.

14. Composition according to claim 12, wherein the composition is a food composition selected from the group consisting of an ice cream, a breakfast cereal, a dehydrated soup, a dehydrated porridge, a food for infants, a confectionery product, a cereal bar, a bakery, a pastry product and a pet food.

15. Process for manufacturing extruded food puffs comprising the steps:
preparing a dry-mix of ingredients comprising more than 20% sweet potato, on a dry basis;
mixing water with the dry-mix ingredients such that the total water content is between 10 and 20%;
extruding the dry-mix ingredients and water together with oil or fat at an extrusion temperature of between 125 and 150° C.;
extruding through a die to form an extrudate with an expansion factor greater than 2, preferably greater than 3;
cutting the extrudate; and
drying the extrudate to a moisture content below 5%.
